(19) United States
(12) Patent Application Publication
(10) Pub. No.: US 2019/0044227 A1
(43) Pub. Date: Feb. 7, 2019

(54) Active Antenna

(71) Applicant: Kenneth Harden, Eden Prairie, MN (US)

(72) Inventor: Kenneth Harden, Eden Prairie, MN (US)

(73) Assignee: BBY SOLUTIONS, INC., Richfield, MN (US)

(21) Appl. No.: 15/665,762

(22) Filed: Aug. 1, 2017

(51) Int. Cl. H01Q 3/04; H01P 1/06; H04B 1/7136

(52) U.S. Cl. CPC H01Q 3/04; H04B 7/02; H04B 1/7136; H01P 1/066

(57) ABSTRACT

An antenna array assembly is described herein. The assembly includes a housing, a plurality of antennas arranged in an array, an antenna switcher in communication with the array and a tuner. The tuner is in communication with the antenna switcher. The tuner has a memory and a channel look-up table contained therein. The look-up table has a remembered association between an optimal signal associated with each channel of the tuner and one of the plurality of antennas. The tuner is configured to automatically select from the look-up table only one of the plurality of antennas that has detected the optimal signal associated with the channel. When that channel is selected by a user the tuner instructs the antenna switcher to switch to the single antenna that is detecting the optimal signal in accordance with the look-up table.

### FIELD OF THE INVENTION

Embodiments of this disclosure are directed to antennas and antenna arrays for use with digital televisions (DTVs)

### SUMMARY

A common complaint associated with antennas for use with DTVs is the occasional if not frequent need to physically rotate or otherwise manipulate an antenna so as to attempt to improve signal reception and/or receive different channels.

Embodiments of the present disclosure eliminate this complaint by providing an antenna array assembly comprising at least two antennas, which form the array, connected to a switch box or antenna switcher and controlled by the tuner of a DTV, or manually by a user directly of by remote control. The tuner includes a memory function, which will remember which antenna works best for a given signal, and automatically signal the switch box to select the appropriate antenna when a user selects a channel. As such the user is never required to physically manipulate the array or its individual antennas.

In some embodiments, the array comprises at least three antennas.

In at least one embodiment the assembly includes one or more inputs through which one or more additional antennas (such as a roof antenna) may be added to the array.

In some embodiments, the array assembly includes a housing that the array and switch box are engaged to or contained within. The housing includes an HDMI or other type of output interface for connection to the DTV tuner. In some embodiments the assembly is integrated into the housing of the DTV.

In at least one embodiment, the assembly includes a remote control input interface, such as a radio frequency (RF) or infra-red (IR) interface. In at least one embodiment remote control of the assembly is via computer or smart phone application.

In some embodiments, the assembly includes a signal strength meter for detecting and displaying the strength of a given (channel) signal being received by one or more of the individual antennas of the array.

In at least one embodiment the individual antenna that is utilized to provide a received signal to the tuner may be manually selected by the user for use from amongst other antennas within the array.

These and other embodiments are described in greater detail below and are illustrated in the following drawings.

### BRIEF DESCRIPTION OF THE DRAWINGS

FIG. 1 is a perspective view of an embodiment of an antenna array assembly having two antennas in the array.

FIG. 2 is a perspective view of an embodiment of an antenna array assembly having three antennas in the array.

FIG. 3 is a diagrammatic illustration of the components that make up the embodiment shown in FIG. 2, and additionally a power source TV monitor and remote control.

FIG. 4 is a table illustrating an example of a channel look-up table.

FIG. 5 shows an alternative embodiment of the assembly depicted in FIG. 3 that incudes additional inputs for connecting one or more extraneous antennas into the array.

FIG. 6 shows an alternative embodiment of the assembly shown in FIG. 3 wherein the assembly is incorporated into a television directly.

FIG. 7 shows an alternative embodiment of the assembly shown in FIG. 3 wherein the manual selection of a specific antenna of the array is provided for using a signal strength meter.

### DETAILED DESCRIPTION

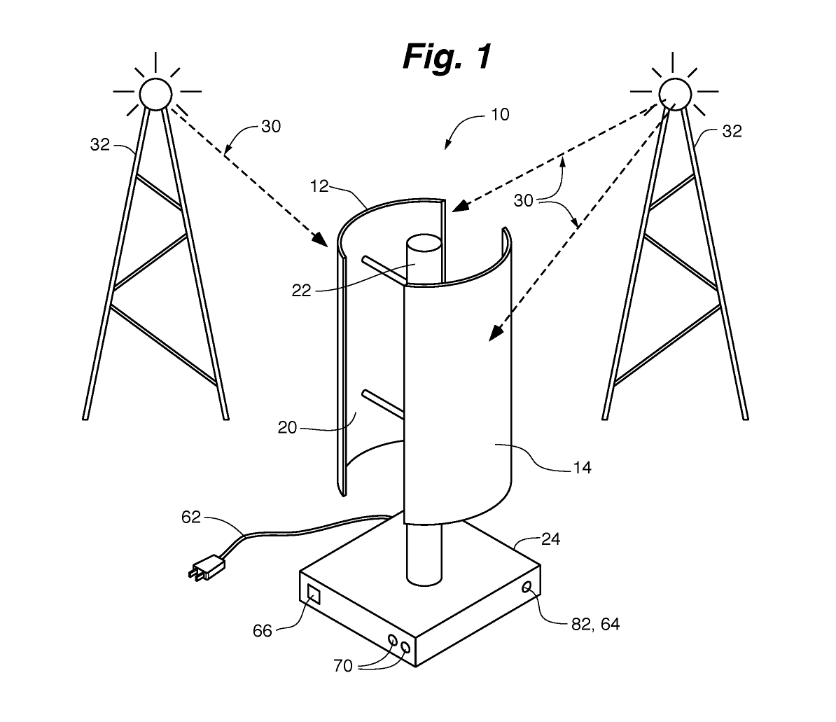

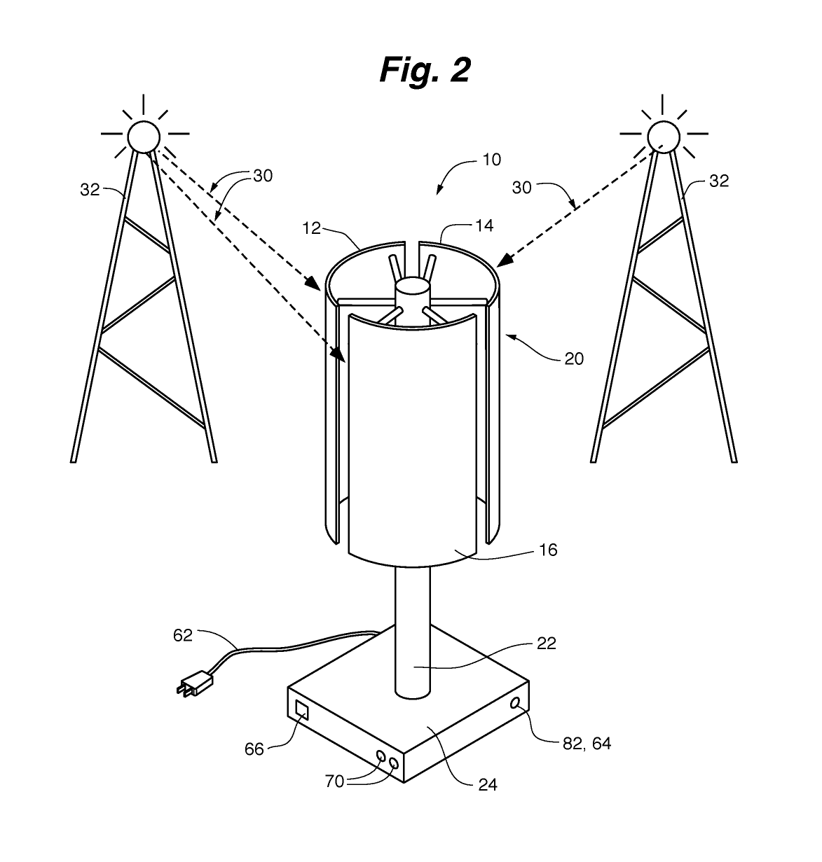

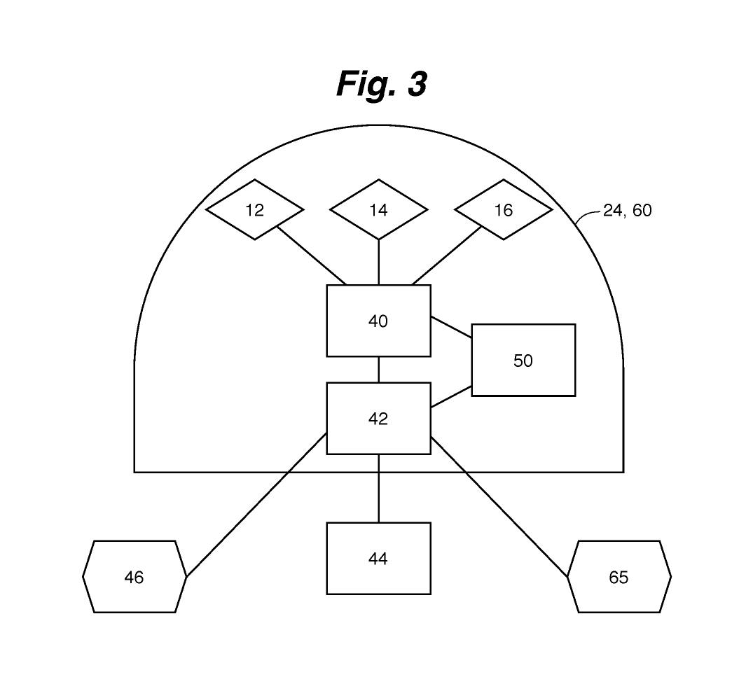

As mentioned above, embodiments of the present disclosure are directed to an antenna array assembly 10 such as is illustrated in FIGS. 1-2. As may be seen in the embodiment depicted in FIG. 1, the assembly 10 includes multiple directional antennas 12 and 14. The assembly 10 will always have at least two antennas, and may be provided with any of a greater number of antennas. For example, in the embodiment shown in FIG. 3, the assembly is provided with three distinct antennas 12, 14 and 16.

The antennas collectively make up an array 20, which may include a mast 22 or any other structure capable of holding the antennas 12, 14 and 16 in a relatively fixed direction orientation. Each antenna 12, 14, 16 may be adjustably mounted on the mast 22 to allow for repositioning of the antennas relative to the mast 22. Engagement of the antennas 12, 14, 16 to the mast 22 may be may any mechanism desired such as by fasteners, adhesives, frictional engagement, etc. Likewise, the mast 22 may be adjustable relative to a base 24 to allow the entire array 20 to be repositioned as desired.

Though such adjustability of the antennas and array may be provided to the assembly 10, the inclusion of multiple antennas in forming the array 20 should make the need for such adjustability unnecessary. By providing the array 20 with a plurality of directional antennas 12, 14, 16, the array will receive a signal 30 sent from a given transmitter 32, by at least one of the individual antennas 12, 14, 16 regardless of the location of the transmitter 32. Multiple signals 30 may be received from multiple transmitters 32, but for each signal at least one antenna 12, 14, 16 will be positioned for optimal detection of a given signal. Thus, the assembly 10 eliminates the need for manual manipulation of the individual antennas 12, 14, 16 or the array 20.

In order to determine which antenna 12, 14, 16 is receiving a signal 32 more optimally that the others, the array 20 is connected to a switch box or antenna switcher 40; which in turn is configured to communicate and be controlled by the tuner 42, which in turn is configured for communication with a DTV or monitor 44. The monitor 44 is any form of visual display device with a built-in TV tuner. The assembly 10 is configured for wireless or wired connection with a TV, monitor, projector, and/or any other form of video display device including computers and related devices.

This communication path way is depicted in FIG. 3. In practice, the tuner 42 will have tried and be programmed to remember which antenna 12, 14, 16 has the best or strongest signal receipt of a signal associated with a user selected channel. This “try and remember” function typically will occur during the channel scan function that a DTV 44 will activate upon its initial setup; though such a function may be activated at any time by the user or incrementally by the tuner 42 as dictated by its programming. Following this initial setup, when a user switches channels on the DTV 44, or via a remote control 46, the tuner 42 will automatically instruct the switcher 40 to switch between the antennas 12, 14, 16 in order to utilize the antenna that is providing the best signal quality for the selected channel.

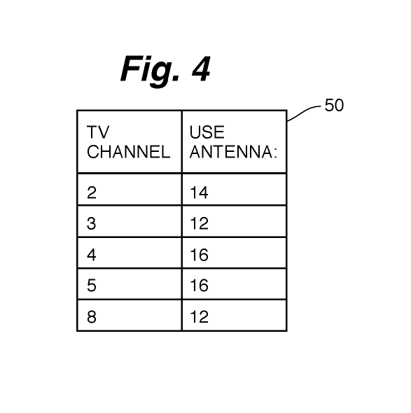

An example of the switcher functionality provided by the communication between the tuner 42, switcher 40 and array 20 is illustrated by the look-up table 50 shown in FIG. 4. As shown, when a user selects a channel on the DTV 44, the tuner 42 will automatically instruct the switcher 40 to select the antenna 12, 14 or 16 which the tuner 42 has established as providing the best signal for the selected channel. Such a look-up table 50 will typically be created during the initial channel scan and television set up as discussed above. If desired, however the tuner 42 may automatically update the channel scan and resulting look-up table based on a variety of triggers such as a GPS signaled change in location of the DTV 44, a desired update period, upon software updates, upon receipt of a signal from the transmitter that the operational characteristics of the transmitter or the transmitted signal are changing or have changed, by a detected change or interruption in a given signal's strength, etc.

In embodiments of the assembly 10, such as are shown in FIG. 3, the array 20, switcher 40, tuner 42 are attached to or contained within a single housing 60 such as in the manner shown in FIGS. 1 and 2. In such a self-contained embodiment the housing my include an internal or external power supply, but will typically require a cord/plug 62 to receive power from a standard 100-120 v AC power outlet (see FIG. 3) 65, though other power sources may be used and the assembly 10 configured appropriately. The assembly 10, communicates with the DTV 44 via an HDMI out port 64 and cable connected thereto or other appropriate interface located on the housing 60 and in communication with the tuner 42.

In at least one embodiment the assembly 10 includes a radio transmitter 68 for WIFI communication with a router or other device to provide wireless communication and interface with the DTV 44 or multiple DTVs, computers or other devices. In some embodiments, housing 60 also will include a receiver node or window 66 for receiving radio, infra-red, or other types of controlling signals from the remote control 46.

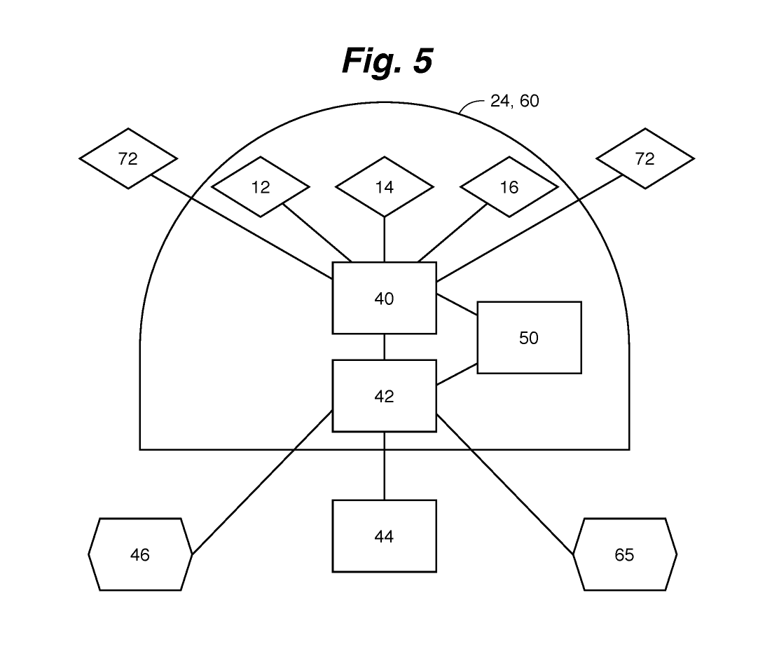

Should it be determined that the assembly of the types shown in FIG. 1 and FIG. 2 are insufficiently positioned or are otherwise blocked from detecting a known transmitted signal, the assembly 10 may include one or more supplemental antenna reception ports 70 to which additional supplemental antennas 72 may be connected to and provide communication with the switcher 40 and tuner 42 such as in the manner shown in FIG. 5. When such a supplemental antenna(s) 72 is added to the assembly 10 the channel scan function may be repeated and the look-up table 50 updated to include the added antenna(s) 72 and thus assign the antenna(s) 72 a channel or channels based on its(their) more optimal receipt of a respective signal.

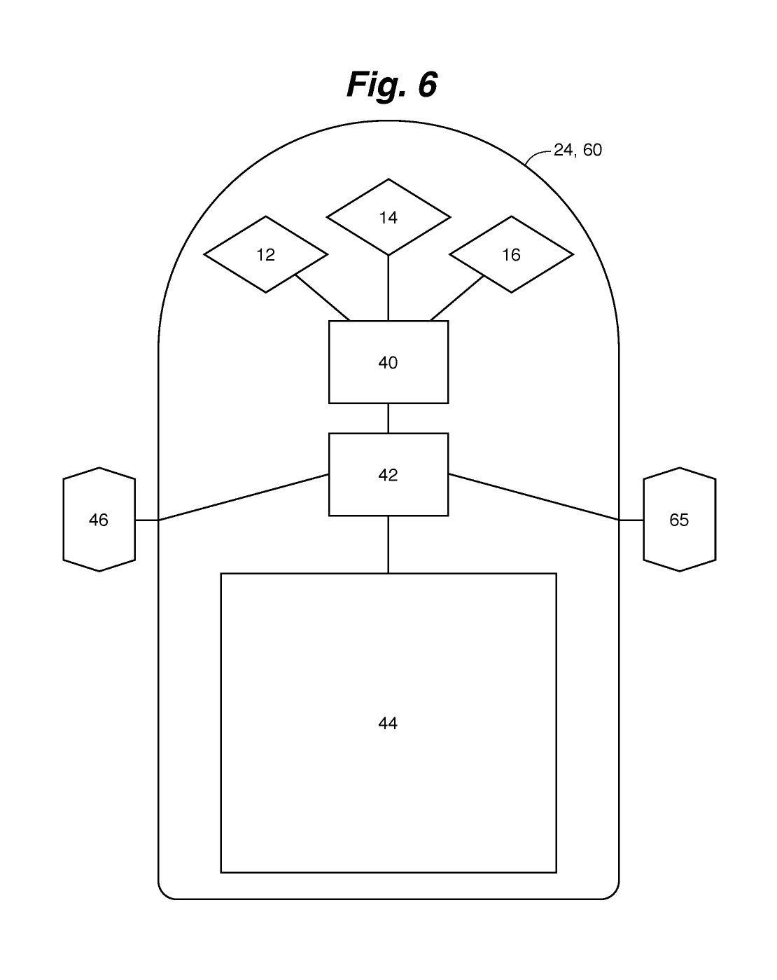

In some embodiments, an example of which is shown in FIG. 6, the housing 60 includes not only the assembly 10 but also the DTV 44 as well. In other words, while embodiments shown in FIGS. 1-3 may be separate “set top” units that interface with a DTV 44, In the embodiment shown in FIG. 6 the assembly 10 is incorporated directly within the physical unit of the DTV 44.

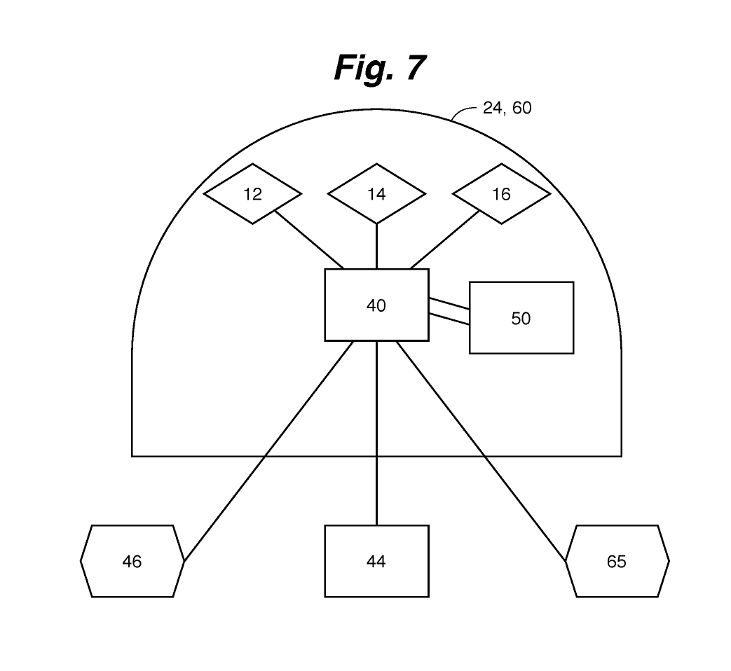

As mentioned above, in some embodiments, it may be desired to provide direct manual control of antenna selection rather than provide automatic antenna selection by optimized signal receipt as determined by the tuner 42. An embodiment depicting such a direct selection assembly 10 and its functionality is depicted in FIG. 7.

In the embodiment shown, the assembly 10 still includes multiple antennas 12, 14, 16, and a switcher 40. But in place of a tuner the assembly is provided with a signal strength meter 80. When operational, the antenna switcher 40 would pick the antenna 12, 14, 16 of the array 20 that is receiving the most channels or the selected channel having sufficient strength to be received by a television tuner as determined by the strength meter 80. The other antennas not receiving the desired signal or sufficient number of signals would go unused. A remote control 46 would allow a user to select from between antennas 12, 14 and 16. With communication to a television 44 via a coax cable interface 82. The lower power requirements of such an assembly 10 allow the assembly to be powered by standard 5 v USB (or equivalents) type connection 85 such as may be provided by direct interface with the television 44. Other power sources may also be utilized, including direct plug in to a 100-120 v wall outlet or even by battery.

The many features and advantages of the invention are apparent from the above description. Numerous modifications and variations will readily occur to those skilled in the art. Since such modifications are possible, the invention is not to be limited to the exact construction and operation illustrated and described. Rather, the present invention should be limited only by the following claims.

1. An antenna array assembly comprising:
a housing;
a plurality of an antennas, each of the plurality of antennas engaged to the housing, the plurality of antennas forming an array;
an antenna switcher, the antenna switcher in communication with each of the plurality of antennas;
a tuner, the tuner having a memory and a channel look-up table stored within the memory, the tuner is in communication with the antenna switcher, the tuner populating the channel look-up table during a channel scan function wherein the look-up table is populated with a remembered association between a strongest signal associated with each channel of the tuner and one of the plurality of antennas, the tuner constructed and arrange to automatically select from the look-up table the one of the plurality of antennas that detects the strongest signal associated with the channel and instruct the antenna switcher to switch to the one of the plurality of antennas when the channel is selected.

2. The assembly of claim 1, wherein the array is formed of at least three antennas.

3. The assembly of claim 2, wherein the antenna switcher and tuner are contained within the housing.

4. The assembly of claim 3, wherein the array is contained within the housing.

5. The assembly of claim 3, wherein the tuner is in communication with a DTV.

6. The assembly of claim 5, wherein the tuner and DTV are in communication with each other via an HDMI interface.

7. The assembly of claim 2, further comprising a DTV, the DTV in communication with the tuner, the DTV, the array, the antenna switcher and tuner are contained within the housing.

8. The assembly of claim 1, wherein the housing defines at least one supplemental antenna port, the at least one supplemental antenna port constructed and arranged to permit communication between at least one supplemental antenna and the antenna switcher, wherein the at least one supplemental antenna is positioned external of the housing.

9. The assembly of claim 8, wherein the at least one supplemental antenna is included on the look-up table.

10. The assembly of claim 1, further comprising a remote control, the remote control being in communication with the tuner via a signal window positioned on the housing.

11. An antenna array assembly comprising:
a housing;
a plurality of an antennas, each of the plurality of antennas engaged to the housing, the plurality of antennas forming an array;
an antenna switcher, the antenna switcher in communication with each of the plurality of antennas;
a signal power meter, the signal power meter in communication with the antenna switcher, the antenna switcher configured to pick one of the plurality of antennas that is receiving the most channels of a sufficient strength as determined by the strength meter.
